(19) United States
(12) Patent Application Publication
(10) Pub. No.: US 2013/0230688 A1
(43) Pub. Date: Sep. 5, 2013

(54) Breathable Insulation

(71) Applicant: Zhen Ping WU, Kaohsiung City (TW)

(72) Inventor: Zhen Ping WU, Kaohsiung City (TW)

(21) Appl. No.: 13/726,191

(22) Filed: Dec. 23, 2012

(30) Foreign Application Priority Data
Dec. 23, 2011 (TW) 100148237

(51) Int. Cl. F16L 59/02

(52) U.S. Cl. CPC F16L 59/02
USPC 428/116; 428/221; 428/190; 428/220

(57) ABSTRACT

The present invention relates to a breathable insulation, could be set on the some part or whole of fabric, cloth, silk, cotton, textile, satin, yarn, linen, wool, synthetic fiber, rayon, polyester fiber, nylon or integrated with part or all of the fabric, cloth, silk, cotton, textile, satin, yarn, linen, wool, synthetic fiber, rayon, polyester fiber, nylon, comprising one or several support units located in the same plane or in different planes to allow air there in convection, with said design, the support units could form three-dimensional spaces to help air convection and to allow warm air come out of human skin. It helps for air distribution and convection, and helps the temperature of the human skin being warm through, not sultry, and achieves the purpose of natural insulation breathable.

### BACKGROUND OF THE INVENTION

1. Field of the Invention

The present invention relates to a insulation, particularly it pertains to a breathable insulation helping for air distribution and convection, and helping the temperature of the human skin being warm through, not sultry, and achieves the purpose of natural insulation breathable.

2. Description of the Related Art

The human body has insulation function that the temperature could be keeping almost constant between 36˜37° C. “Skin” is the body's largest organ tissue. The main functions of the skin could protect the internal organs, perspiration, and detoxification. Although skin can mediate body temperature, however, the body temperature could be affected by temperature susceptible to environmental factors, and could be affected by the blood circulation in the body condition. At this situation, if person is unable to immediately replace the appropriate clothing, it will cause bodily sultry, airtight, or cold.

The body temperature is the performance of the heat generated in the metabolic processes of the human body substances and is also one of the essential elements of various physiological reactions of human cells. When the body temperature is elevated, the blood circulation is accelerated and sweating is increased to effectively dissipate; conversely, when the temperature drops, the blood circulation is slow down to prevent the distribution of heat. From this above, the regulation of body temperature for the human body has play a very important role.

### SUMMARY OF THE INVENTION

The inventor of the present invention has spent years researching and developing a breathable insulation to simulate the human skin.

The present invention relates to a breathable insulation, could be set on the some part or whole of fabric, cloth, silk, cotton, textile, satin, yarn, linen, wool, synthetic fiber, rayon, polyester fiber, nylon or integrated with part or all of the fabric, cloth, silk, cotton, textile, satin, yarn, linen, wool, synthetic fiber, rayon, polyester fiber, nylon, comprising one or several support units located in the same plane or in different planes to allow air there in convection, with said design, the support units could form three-dimensional spaces to help air convection and to allow warm air come out of human skin, said breathable insulation could be made into apparel, hats, scarves, neck protection, ear protection, eye protection, shoulder pads, gloves, elbow pads, chest, belly, waist, thigh, calf, knee pads, socks, underwear, underwear, women bra, mattresses, quilts, vests, clothing, sleeping bags, pillows, pillows, cuff, scapula set, masks, bedding, cushions, and human clothing for users wearing, covering and coating.

The main aim of the present invention is to helping for air distribution and convection, and helping the temperature of the human skin being warm through, not sultry, and achieves the purpose of natural insulation breathable.

### BRIEF DESCRIPTION OF THE DRAWINGS

FIG. 1 is a diagram showing the first embodiment of the present invention.

FIG. 2 is a diagram showing the second embodiment of the present invention.

FIG. 3 is a diagram showing the third embodiment of the present invention.

### DETAILED DESCRIPTION OF THE PREFERRED EMBODIMENT

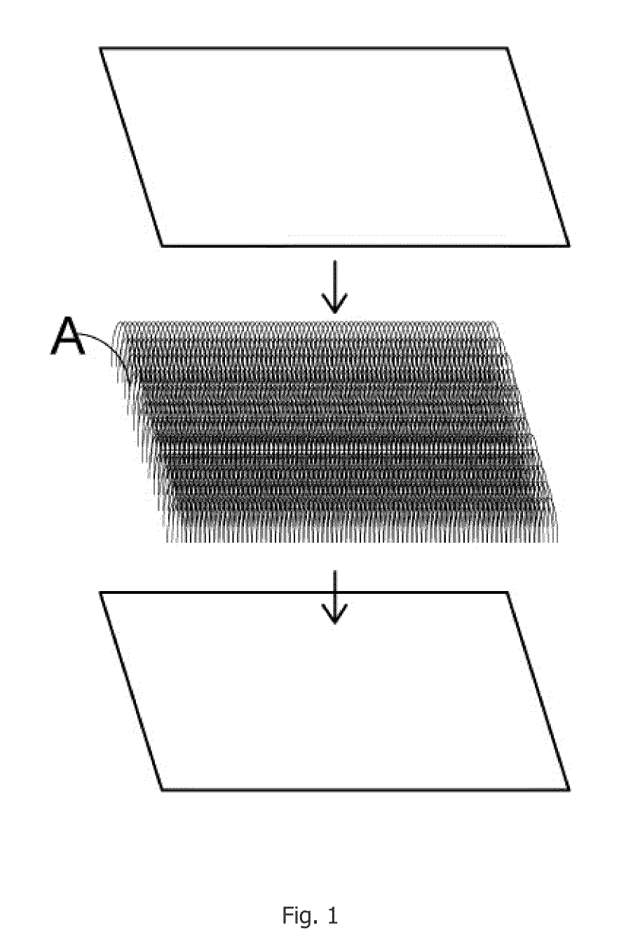

Please refer to FIG. 1, FIg. 1 is a diagram showing the first embodiment of the present invention. The breathable insulation of the present invention, could be set on the some part or whole of fabric, cloth, silk, cotton, textile, satin, yarn, linen, wool, synthetic fiber, rayon, polyester fiber, nylon or integrated with part or all of the fabric, cloth, silk, cotton, textile, satin, yarn, linen, wool, synthetic fiber, rayon, polyester fiber, nylon, comprising one or several support units A located in the same plane or in different planes (the planes are up and down or left and right stack) to allow air there in convection, with said design, the support units A could form three-dimensional spaces to help air convection and to allow warm air come out of human skin, said breathable insulation could be made into apparel, hats, scarves, neck protection, ear protection, eye protection, shoulder pads, gloves, elbow pads, chest, belly, waist, thigh, calf, knee pads, socks, underwear, underwear, women bra, mattresses, quilts, vests, clothing, sleeping bags, pillows, pillows, cuff, scapula set, masks, bedding, cushions, and human clothing for users wearing, covering and coating, it helps for air distribution and convection, and helps the temperature of the human skin being warm through, not sultry, and achieves the purpose of natural insulation breathable.

Said one or several support units A of the present invention could be made one kind or several kinds of synthetic fiber, rayon, polyester fiber, and nylon. The thickness of said one or several support units A could be 1 mm to 50 mm for applying to different seasons or for coating or covering over different pan of human skin.

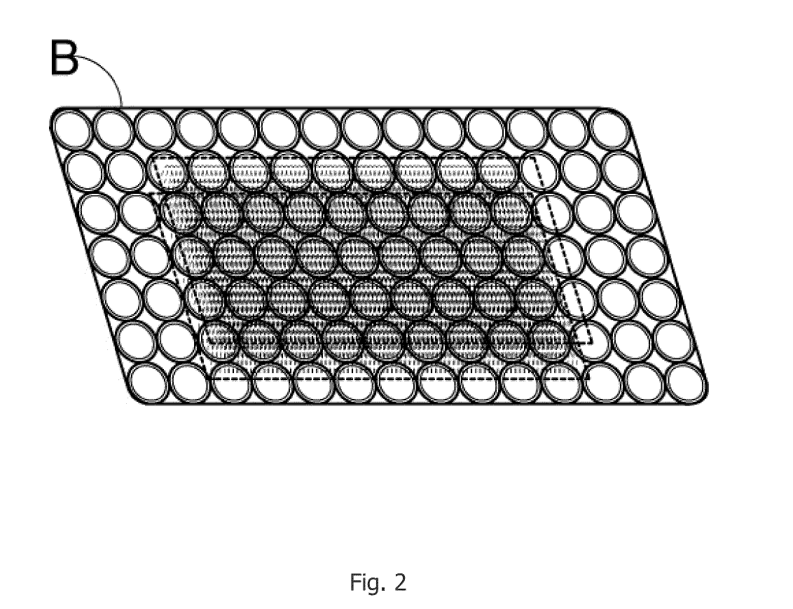

Please refer to FIG. 2, FIG. 2 is a diagram showing the second embodiment of the present invention. Said one or several support units A of the present invention could be integrated with one kind or several kinds of apparel, hats, scarves, neck protection, ear protection, eye protection, shoulder pads, gloves, elbow pads, chest, belly, waist, thigh, calf, knee pads, socks, underwear, underwear, women bra, mattresses, quilts, vests, clothing, sleeping bags, pillows, pillows, cuff, scapula set, masks, bedding, cushions B, and human clothing.

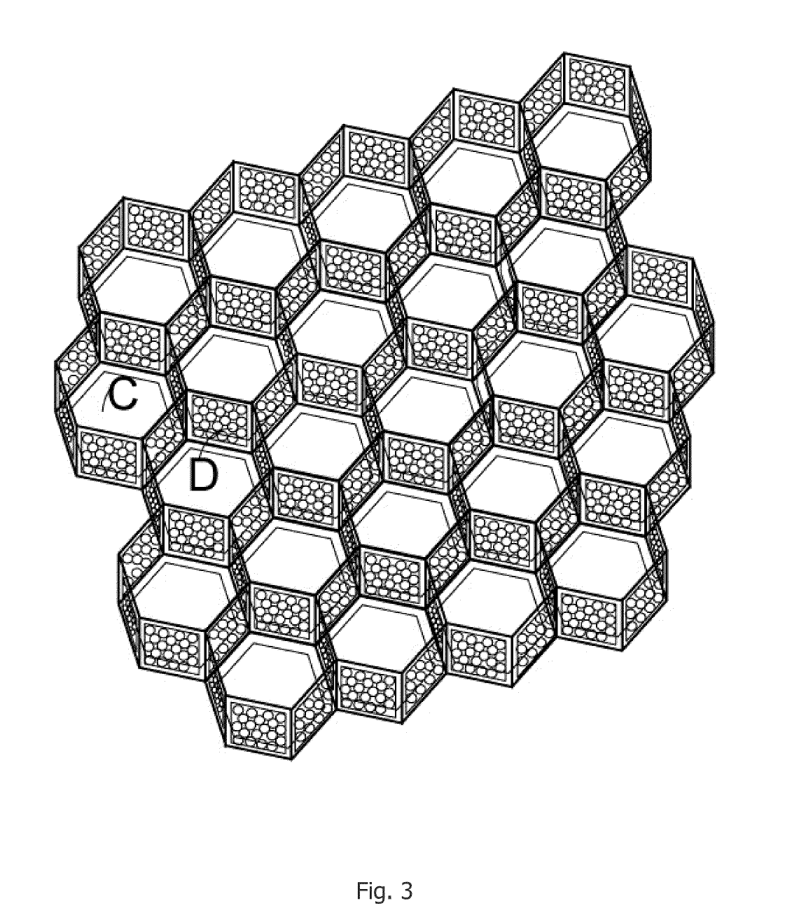

Please refer to FIG. 3, FIG. 3 is a diagram showing the third embodiment of the present invention. The breathable insulation of the present invention, could be set on the some part or whole of fabric, cloth, silk, cotton, textile, satin, yarn, linen, wool, synthetic fiber, rayon, polyester fiber, nylon or integrated with part or all of the fabric, cloth, silk, cotton, tetile, satin, yarn, linen, wool, synthetic fiber, rayon, polyester fiber, nylon, comprising several hole structures C, there are channels, holes, pussy existing between each hole structures C to allow air there in convection, with said design, the hole structures C could form three-dimensional spaces to help air convection and to allow warm air come out of human skin, said breathable insulation could be made into apparel, hats, scarves, neck protection, ear protection, eye protection, shoulder pads, gloves, elbow pads, chest, belly, waist, thigh, calf, knee pads, socks, and underwear, women bra, mattresses, quilts, vests, clothing, sleeping bags, pillows, pillows, cuff, scapula set, masks, bedding, cushions, and human clothing for users wearing, covering and coating, it helps for air distribution and convection, and helps the temperature of the human skip being warm through, not sultry, and achieves the purpose of natural insulation breathable. The shape of the hole structures C could be circular, triangular, square, polygonal, irregular shaped, or diamond.

Besides, said several hole structures C could be made one kind or several kinds of synthetic fiber, rayon, polyester fiber, and nylon. The thickness of said hole structures C could be 1 mm to 50 mm for applying to different seasons or for coating or covering over different part of human's skin. Said several hole structures C could be integrated with one kind or several kinds of apparel, hats, scarves, neck protection, ear protection, eye protection, shoulder pads, gloves, elbow pads, chest, belly, waist, thigh, calf, knee pads, socks, underwear, underwear, women bra, mattresses, quilts, vests, clothing, sleeping bags, pillows, pillows, cuff, scapula set, masks, bedding, cushions, and human clothing.

The breathable insulation of the present invention can be used to cover or coat any part of the human skin for keeping warm effect. It is not only used for person wearing, but also can be used for pets wearing.

It is worth to mention that the invention is worked as an ultra human skin so that it could achieves the purpose of natural insulation breathable.

As is understood by a person skilled in the art, the foregoing preferred embodiment of the present invention is an illustration, rather than a limiting description of the present invention. It is intended to cover various modifications and similar arrangements, for example, the amount of the support units or the hole structures, and the position of the support units or the hole structures etc., all the above may vary and should be considered within the spirit and scope of the appended claims of the present invention. In short, the spirit and scope should be accorded the broadest interpretation so as to encompass all such modifications and similar structures.

What is claimed:

1. The breathable insulation, could be set on the some part or whole of fabric, cloth, silk, cotton, textile, satin, yarn, linen, wool, synthetic fiber, rayon, polyester fiber, nylon or integrated with part or all of the fabric, cloth, silk, cotton, textile, satin, yarn, linen, wool, synthetic fiber, rayon, polyester fiber, nylon, comprising one or several support units located in the same plane or in different planes to allow air there in convection, with said design, the support units could form three-dimensional spaces to help air convection and to allow warm air come out of human skin, said breathable insulation could be made into apparel, hats, scarves, neck protection, ear protection, eye protection, shoulder pads, gloves, elbow pads, chest, belly, waist, thigh, calf, knee pads, socks, underwear, underwear, women bra, mattresses, quilts, vests, clothing, sleeping bags, pillows, pillows, cuff, scapula set, masks, bedding, cushions, and human clothing for users wearing, covering and coating, it helps for air distribution and convection, and helps the temperature of the human skin being warm through, not sultry, and achieves the purpose of natural insulation breathable.

2. The breathable insulation as in claim 1, wherein said one or several support units could be made one kind or several kinds of synthetic fiber, rayon, polyester fiber, and nylon.

3. The breathable insulation as in claim 1, wherein the thickness of said one or several support units could be 1 mm to 50 mm.

4. The breathable insulation as in claim 1, wherein said one or several support units could be integrated with one kind or several kinds of apparel, hats, scarves, neck protection, ear protection, eye protection, shoulder pads, gloves, elbow pads, chest, belly, waist, thigh, calf, knee pads, socks, underwear, underwear, women bra, mattresses, quilts, vests, clothing, sleeping bags, pillows, pillows, cuff, scapula set, masks, bedding, cushions, and human clothing.

5. The breathable insulation, could be set on the some part or whole of fabric, cloth, silk, cotton, textile, satin, yarn, linen, wool, synthetic fiber, rayon, polyester fiber, nylon or integrated with part or all of the fabric, cloth, silk, cotton, textile, satin, yarn, linen, wool, synthetic fiber, rayon, polyester fiber, nylon, comprising several hole structures, there are channels, holes, pussy existing between each hole structures to allow air there in convection, with said design, the hole structures could form three-dimensional spaces to help air convection and to allow warm air come out of human skin, said breathable insulation could be made into apparel, hats, scarves, neck protection, ear protection, eye protection, shoulder pads, gloves, elbow pads, chest, belly, waist, thigh, calf, knee pads, socks, underwear, underwear, women bra, mattresses, quilts, vests, clothing, sleeping bags, pillows, pillows, cuff, scapula set, masks, bedding, cushions, and human clothing for users wearing, covering and coating, it helps for air distribution and convection, and helps the temperature of the human skin being warm through, not sultry, and achieves the purpose of natural insulation breathable.

6. The breathable insulation as in claim 5, wherein said several hole structures could be made one kind or several kinds of synthetic fiber, rayon, polyester fiber, and nylon.

7. The breathable insulation as in claim 5, wherein the thickness of said hole structures could be 1 mm to 50 mm.

8. The breathable insulation as in claim 5, wherein the shape of the hole structures could be circular, triangular, square, polygonal, irregular shaped, or diamond.

9. The breathable insulation as in claim 5, wherein said several hole structures could be integrated with one kind or several kinds of apparel, hats, scarves, neck protection, ear protection, eye protection, shoulder pads, gloves, elbow pads, chest, belly, waist, thigh, calf, knee pads, socks, underwear, underwear, women bra, mattresses, quilts, vests, clothing, sleeping bags, pillows, pillows, cuff, scapula set, masks, bedding, cushions, and human clothing.
